(19) United States
(12) Patent Application Publication
(10) Pub. No.: US 2012/0282980 A1
(43) Pub. Date: Nov. 8, 2012

(54) MOBILE COMMUNICATION DEVICE APPARATUS HAVING MULTIPLE MOBILE DEVICES

(75) Inventors: Joseph Michael Freund, Fogelsville, PA (US); Anthony Grewe, Fogelsville, PA (US); Sailesh Merchant, Macungie, PA (US); David Herring, Berkeley Heights, NJ (US)

(73) Assignee: LSI Corporation, Milpitas, CA (US)

(21) Appl. No.: 13/101,222

(22) Filed: May 5, 2011

(51) Int. Cl. H04W 88/02

(52) U.S. Cl. 455/566

(57) ABSTRACT

A mobile communication device having a plurality of mobile devices coupled to one another. The mobile communication device includes a first mobile device that has a screen display portion and a user input portion. The mobile communication device also includes at least one second mobile device detachably coupled to the first mobile device. The first mobile device is configured to function as a first standalone mobile communication device, and the second mobile device is configured to function as a second standalone mobile communication device when detached from the first mobile device. The second mobile device is detachably coupled to the first mobile device in such a way that the first mobile device continues to include the display screen portion and the user input portion when the second mobile device is detached from the first mobile device.

### BACKGROUND OF THE INVENTION

1. Field of the Invention

The invention relates to mobile communication devices. More particularly, the invention relates to mobile communication devices having multiple mobile devices.

2. Description of the Related Art

Mobile communication devices, which include cellular or mobile phones, smart phones, personal digital assistants (PDAs), handheld computing devices, navigation devices and other devices, allow a user to communicate wirelessly via a suitable wireless communication protocol. Mobile communication devices can have various forms or configurations. For example, a mobile communication device can have two portions that are hinged together in such a way that the two portions can be opened and closed in a clam shell configuration. In such configuration, the first portion typically includes a viewing screen, and the second portion typically includes a keypad on its inner top surface and a mobile communication device processor contained therein. Alternatively, a mobile communication device can be a single tablet module or device that includes a touchpad screen or other screen on its top surface and a mobile communication device processor contained therein. A tablet mobile communication device also can include a keypad on its top surface in addition to a viewing screen.

Oftentimes, a mobile communication device user would like to be able to stay in contact with another member of their party via the mobile communication device. For example, a parent may want to stay in contact with a child via the mobile communication device. However, the child or other party member may not have their own mobile communication device with which to remain in contact with the primary mobile communication device user.

Conventional mobile communication devices include a mobile communication device having two modules hinged together in a clam shell configuration, in which the two modules can be detached or separated from one another and that have the appropriate components to allow the two modules to communicate with one another via a suitable wireless protocol. For example, see U.S. Pat. No. 7,826,876 B2, issued to Su. However, the primary mobile communication device has a greatly reduced viewing and user input area once the two modules are detached from one another. For example, once separated, the primary module has a viewing and user input area that is approximately one half the size of the viewing and user input area of the mobile communication when the two modules are coupled together. Also, such conventional mobile communication devices have relatively limited functionality for each module once the two modules are detached from one another, beyond the ability to communicate with one another. That is, once the two modules are detached from one another, each module typically is not a fully functional mobile communication device, rather the two modules typically only can communicate with one another.

### SUMMARY OF THE INVENTION

The invention is embodied in a mobile communication device having a plurality of mobile devices coupled to one another. The mobile communication device includes a first mobile device having a screen display portion and a user input portion. The mobile communication device also includes at least one second mobile device detachably coupled to the first mobile device. The first mobile device is configured to function as a first standalone mobile communication device and the second mobile device is configured to function as a second standalone mobile communication device when the second mobile device is detached from the first mobile device. According to embodiments of the invention, the first mobile device continues to include the display screen portion and the user input portion when the second mobile device is detached from the first mobile device.

### BRIEF DESCRIPTION OF THE DRAWINGS

FIG. 1 is a schematic view of a conventional mobile communication device having a clam shell configuration;

FIG. 2 is a schematic view of a conventional mobile communication device having two communication modules, in a clam shell configuration, showing the two communication modules detached from one another;

FIG. 3A is a schematic view of a mobile communication device, including a clam shell mobile device and a tablet mobile device attached to one another according to an embodiment of the invention;

FIG. 3B is a schematic view of the mobile communication device of FIG. 3A, showing the clam shell mobile device and the tablet mobile device detached from one another according to an embodiment of the invention;

FIG. 4A is a schematic view of a mobile communication device, including a clam shell mobile device and two tablet mobile devices, attached to one another according to an embodiment of the invention; and

FIG. 4B is a schematic view of the mobile communication device of FIG. 4A, showing the two tablet mobile devices detached from the clam shell mobile device according to an embodiment of the invention.

### DETAILED DESCRIPTION OF EXEMPLARY EMBODIMENTS

In the following description, like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

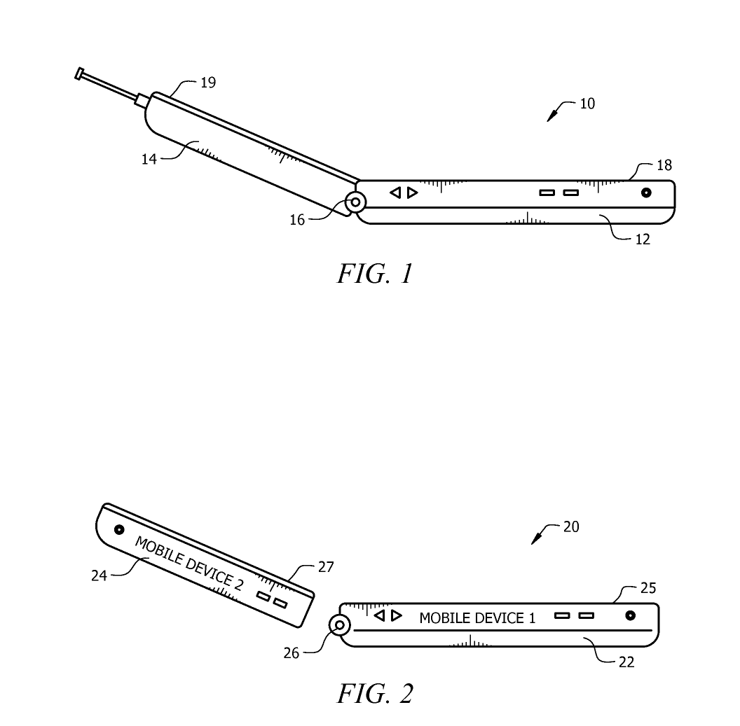

Referring to FIG. 1, shown is a schematic view of a conventional mobile communication device 10, such as a cellular phone, having a clam shell configuration. The mobile communication device 10 includes a first module or portion 12 and a second module or portion 14. The two modules 12, 14 are hinged or otherwise connected to one another by a hinge or other suitable connecting element 16.

The first module 12 typically includes a keypad or other appropriate user input interface as part of a top surface 18 of the first module 12. Also, the first module 12 typically includes therein a plurality of components and other elements (not shown) that manage and control the functions of the mobile communication device 10. For example, the first module 12 can include a power supply, such as a rechargeable battery, for supplying necessary power to the mobile communication device 10. The first module 12 also can include a microphone, a speaker, a light source, a connector port, a SIM card, a memory card and/or other suitable components that allow for the storage of information, and other suitable components that allow for proper operation of the mobile communication device 10. The first module 12 also includes a processor or controller for managing and controlling the various components of the mobile communication device 10.

The second module 14 typically includes a display or viewing screen (not shown) as part of a top surface 19 of the second module 14. The screen can be used for viewing only or, alternatively, can be a touchscreen configured to receive user input via user contact with various areas of the touchscreen surface. The second module 14 is configured so that the screen is operationally coupled to the necessary components in the first module 12 for proper operation of the screen and proper screen display.

In many conventional mobile communication devices having a clam shell configuration, the first module 12 and the second module 14 work in conjunction with one another to provide the features and functionality of the mobile communication device 10. That is, neither the first module 12 nor the second module 14 can operate properly without the connection to and cooperation of the other module. For example, the screen included as part of the second module 14 cannot operate properly without being properly connected to the processor within the first module 12.

However, some conventional mobile communication devices are configured in such a way that the first and second modules can be detached from one another and can communicate with one another via an appropriate radio frequency link or other appropriate wireless communication link. Referring now to FIG. 2, shown is a schematic view of a conventional mobile communication device 20 having a clam shell configuration with two detachable communication modules. The mobile communication device 20 includes a first mobile device 22 and a second mobile device 24 that are detachably connected by a hinging element 26. The first mobile device 22 and the second mobile device 24 each are configured to be able to communicate with the other mobile device when the first mobile device 22 and the second mobile device 24 are detached from one another.

However, with such conventional mobile communication devices, the area of the viewing screen and/or the user input area for the primary mobile device is greatly reduced compared to conventional mobile communication devices having a pair of modules coupled together as a single mobile communication device. For example, for the mobile communication device 20, when the first mobile device 22 and the second mobile device 24 are coupled together and operating as a single mobile communication device 20, a top surface 25 of the first mobile device 22 can be used for a keypad of other suitable user input interface and a top surface 27 of the second mobile device 24 can be used for a display or viewing screen.

However, once the first mobile device 22 and the second mobile device 24 are detached from one another, the primary mobile device 22 and the second mobile device 24 has to provide both a suitable display or viewing screen and a suitable user input interface or region for each mobile device to operate as a standalone mobile communication device. Not only does each mobile device have to provide both a suitable display or viewing screen and a suitable user input interface, but also each mobile device, once detached from the other mobile device, now only has approximately half of the area or surface area to provide both a suitable display and user input interface. Therefore, one or both of the viewing screen and the user input interface must be reduced in size or somehow incorporated into the same usable area.

Also, with such conventional mobile communication devices, each mobile device typically is able to communicate only with the mobile device from which it was detached. That is, once detached, neither the first mobile device 22 nor the second mobile device 24 are configured to operate as an independent or standalone mobile communication device.

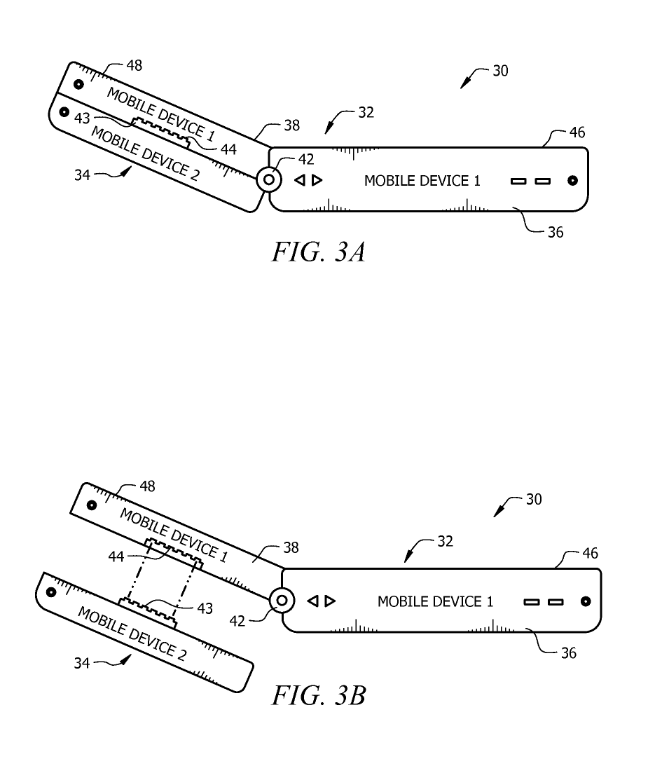

Referring to FIG. 3A, shown is a schematic view of a mobile communication device 30 including a clam shell mobile device (mobile device 1) 32 and a tablet mobile device (mobile device 2) 34 coupled to one another according to an embodiment of the invention. The clam shell mobile device 32 includes two portions or modules: a first or user input mobile device module 36 and a second or display screen module 38. The first mobile device module 36 and the second mobile device module 38 are coupled together by any suitable manner, e.g., by a hinge or other connecting element 42. According to embodiments of the invention, both the clam shell mobile device 32 and the tablet mobile device 34 can be any suitable mobile communication device, such as a cellular or mobile phone, a smart phone, a personal digital assistant (PDA), a handheld computing device, a navigation device or other mobile communication device.

The first mobile device module 36 typically includes a keypad or other appropriate user input interface as part of a top surface 46 of the first mobile device module 36. Also, the first mobile device module 36 typically contains therein a plurality of components and other elements (not shown) that manage and control the functions of the first mobile device module 36. For example, the first mobile device module 36 can include a power supply, such as a rechargeable battery, for supplying necessary power to the mobile communication device 30. The first module 36 also can include a microphone, a speaker, a light source, a connector port, and other suitable components that allow for proper operation of the mobile communication device 30. The first mobile device module 36 also includes a processor or controller for managing and controlling the various components of the clam shell mobile device 32, including the components of the second mobile device module 38.

The second mobile device module 38 typically includes a display or viewing screen (not shown) as part of a top surface 48 of the second mobile device module 38. The screen can be used for viewing only or, alternatively, can be a touchscreen configured to receive user input via contact with various areas of the touchscreen. The second mobile device module 38 is configured in such a way that the screen is operationally coupled to the necessary components in the first mobile device module 36 for proper operation of the screen and proper screen display.

The tablet mobile device 34 typically includes a touchscreen (not shown) as part of a top surface of the tablet mobile device 34. The touchscreen is configured to receive user input via contact by the user or an input stylus to various areas of the touchscreen surface. Alternatively, the tablet mobile device 34 can include a display or viewing screen (not shown) as part of the top surface of the tablet mobile device 34. The tablet mobile device 34 also includes therein a plurality of components and other elements (not shown) that manage and control the functions of the tablet mobile device 34. For example, the tablet mobile device 34 can include a power supply, such as a rechargeable battery, for supplying necessary power to the tablet mobile device 34. The tablet mobile device 34 also can include a microphone, a speaker, a light source, a connector port, a SIM card, a memory card and/or other suitable components that allow for the storage of information, and other suitable components that allow for proper operation of the tablet mobile device 34. The tablet mobile device 34 also includes a processor or controller for managing and controlling the various components of the tablet mobile device 34. The tablet mobile device 34 also can include keypad or other appropriate user input interface, which can be part of the top surface of the tablet mobile device 34. Alternatively, the keypad or other appropriate user input interface can extract from the body of the tablet mobile device 34 for use and retract back into the body of the tablet mobile device 34 when not in use.

According to embodiments of the invention, the tablet mobile device 34 is coupled to the clam shell mobile device 32 via the connecting element 42 or in any other suitable manner. For example, the tablet mobile device 34 can include one or more coupling elements 43 formed on one of the surfaces of the tablet mobile device 34, and one side of the second mobile device module 38 of the first mobile device 32 can include one or more corresponding coupling recesses 44 formed therein. In such configuration, the coupling element 43 is aligned with and depressed into the corresponding coupling recesses 44 in such a manner that the tablet mobile device 34 is detachably coupled to the first mobile device 32.

Alternatively, the tablet mobile device 34 can be coupled to the clam shell mobile device 32 via one or more snap-fit brackets or other coupling elements, which may be part of the tablet mobile device 34 and/or one or more of the first mobile device module 36 and the second mobile device module 38. Alternatively, the tablet mobile device 34 or one or more of the first mobile device module 36 and the second mobile device module 38 may have flanges along at least one side thereof that slidably fit into corresponding grooves or other appropriately dimensioned features on the component to which the mobile device is coupled.

It should be noted that the tablet mobile device 34 can be coupled or attached to the clam shell mobile device 32 in any suitable configuration. For example, the tablet mobile device 34 can be coupled or attached to the clam shell mobile device 32 in such a way that its bottom side is exposed, or the tablet mobile device 34 can be coupled or attached to the clam shell mobile device 32 in such a way that its top side is exposed. Also, the tablet mobile device 34 is coupled to the clam shell mobile device 32 in a manner that does not increase the overall footprint of the clam shell mobile device 32. In this manner, a mobile communication device user can carry a mobile communication device that has the same overall footprint as a conventional mobile communication device, but with the ability to be used as two separate, independent standalone mobile communication devices. It should be understood that other advantageous configurations are possible for connecting the tablet mobile device 34 to the clam shell mobile device 32.

However, unlike conventional mobile communication devices having detachable mobile devices, according to embodiments of the invention, each of the clam shell mobile device 32 and the tablet mobile device 34 are configured to operate as standalone mobile communication devices. That is, even when the tablet mobile device 34 is detached from the clam shell mobile device 32, both mobile devices can operate as separate, independent standalone mobile devices. Furthermore, even when the tablet mobile device 34 is detached from the clam shell mobile device 32, neither the clam shell mobile device 32 nor the tablet mobile device 34 has to sacrifice any display or viewing size and/or any user input interface size to operate as a standalone mobile communication device. That is, even when the tablet mobile device 34 is detached from the clam shell mobile device 32, the clam shell mobile device 32 continues to include the second mobile device module 38 and its screen display, as well as the first mobile device module 36 and its user input interface.

Also, it should be understood that one or more of the coupling elements can provide mechanical coupling only, electrical coupling only, or both mechanical and electrical coupling. Also, one or more of the coupling elements can provide direct or indirect electrical coupling. For example, one or more of the coupling elements can place the second and/or third mobile devices in sufficiently close proximity to the first mobile device such that electrical coupling is achieved via magnetic fields or RF (radio frequency) waves. Such direct or indirect electrical coupling can be used for communication, power and/or clocking purposes.

FIG. 3B shows a schematic view of the mobile communication device 30 with the tablet mobile device 34 detached from the first clam shell mobile device 32. According to embodiments of the invention, when the tablet mobile device 34 is detached from the clam shell mobile device 32, the clam shell mobile device 32 can operate as a first standalone mobile communication device and the tablet mobile device 34 can operate as a second standalone mobile communication device, independent of the first mobile communication device.

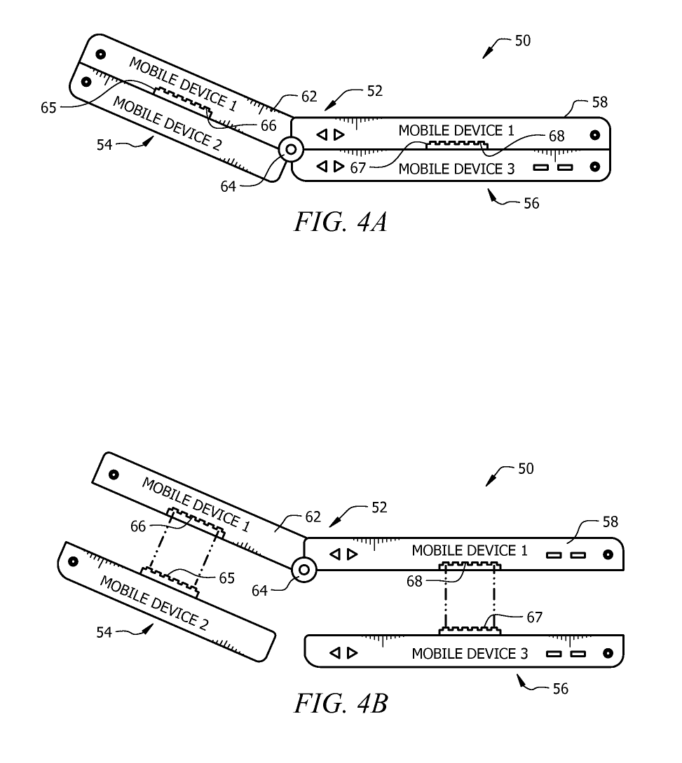

According to embodiments of the invention, more than two mobile communication devices can be attached to one another. Referring to FIG. 4A, shown is a schematic view of a mobile communication device 50, including a clam shell mobile communication device (mobile device 1) 52, a first tablet mobile device (mobile device 2) 54 attached to the clam shell mobile communication device 52, and a second tablet mobile device (mobile device 3) 56 attached to the clam shell mobile communication device 52 according to an embodiment of the invention. The clam shell mobile device 52 includes a first mobile device module 58 and a second mobile device module 62, coupled together by a hinge or other suitable connecting element 64.

As shown, one of the tablet mobile communication devices, e.g., the first tablet mobile device 54, can be detachably coupled to the second mobile device module 62 and the other tablet mobile device, e.g., the second tablet mobile device 56, can be detachably coupled to the first mobile device module 58. In this manner, two additional standalone mobile communication devices (i.e., the first tablet mobile device 54 and the second tablet mobile device 56) are attached to the clam shell mobile device 52 in a manner that does not increase the overall footprint of the clam shell mobile device 52. Therefore, a mobile communication device user can carry a mobile communication device that has the same overall footprint as a conventional mobile communication device, but with the ability to be used as three separate standalone mobile communication devices. Furthermore, even when one or both of the first tablet mobile device 54 and the second tablet mobile device 56 are detached from the clam shell mobile device 52, none of the clam shell mobile device 52, the first tablet mobile device 54 or the second tablet mobile device 56 have to sacrifice any display or viewing size and/or any user input interface size to operate as a standalone mobile communication device. That is, when one or both of the first tablet mobile device 54 and the second tablet mobile device 56 are detached from the clam shell mobile device 52, the clam shell mobile device 52 continues to include the second mobile device module 62 and its screen display, as well as the first mobile device module 58 and its user input interface.

It should be understood that other advantageous configurations are possible for connecting the first tablet mobile device 54 and the second tablet mobile device 56 to the clam shell mobile communication device 52.

According to embodiments of the invention, the first tablet mobile communication device 54 and the second tablet mobile communication device 56 are coupled to the clam shell mobile device 52 via the connecting element 64 or in any other suitable manner. For example, the first tablet mobile device 54 can include one or more coupling elements 65 formed on one of the surfaces of the first tablet mobile device 54, and one side of the second mobile device module 62 of the clam shell mobile communication device 52 can include one or more corresponding coupling recesses 66 formed therein. In such configuration, the coupling element 65 is aligned with and depressed into the corresponding coupling recess 66 in such a manner that the first tablet mobile device 54 is detachably coupled to the second mobile device module 62 of the clam shell mobile communication device 52.

Similarly, the second tablet mobile device 56 can include one or more coupling elements 67 formed on one of the surfaces of the second tablet mobile device 56, and one side of the first mobile device module 58 of the clam shell mobile communication device 52 can include one or more corresponding coupling recesses 68 formed therein. In such configuration, the coupling element 67 is aligned with and depressed into the corresponding coupling recess 68 in such a manner that the second tablet mobile device 56 is detachably coupled to the first mobile device module 58 of the clam shell mobile communication device 52.

Alternatively, either one or both of the first tablet mobile device 54 and the second tablet mobile device 56 can be coupled to the clam shell mobile device 52 via one or more snap-fit brackets or other coupling elements, which may be part of the particular tablet mobile device and/or one or more of the first mobile device module 58 and the second mobile device module 62. Alternatively, one or both of the tablet mobile devices 54, 56 may have flanges along at least one side thereof that slidably fit into corresponding grooves or other appropriately dimensioned features on the component to which the mobile device is coupled.

It should be noted that the tablet mobile devices 54, 56 can be coupled or attached to the clam shell mobile device 52 in any suitable configuration. For example, one or both of the tablet mobile devices 54, 56 can be coupled or attached to the clam shell mobile device 52 in such a way that its respective bottom side is exposed, or in such a way that its respective top side is exposed.

Also, it should be understood that one or more of the coupling elements can provide mechanical coupling only, electrical coupling only, or both mechanical and electrical coupling. Also, one or more of the coupling elements can provide direct or indirect electrical coupling. For example, one or more of the coupling elements can place the second and/or third mobile devices in sufficiently close proximity to the first mobile device such that electrical coupling is achieved via magnetic fields or RF (radio frequency) waves. Such direct or indirect electrical coupling can be used for communication, power and/or clocking purposes.

Referring now to FIG. 4B, shown is a schematic view of the mobile communication device 50 of FIG. 4A, showing the two tablet mobile devices 54, 56 detached from the clam shell mobile device 52 according to an embodiment of the invention. Unlike conventional mobile communication devices having detachable mobile devices that can communicate only with one another, according to embodiments of the invention, each of the clam shell mobile device 52, the first tablet mobile device 54 and the second tablet mobile device 56 are configured to operate as standalone mobile communication devices independent of one another. Therefore, even when one or both of the tablet mobile devices 54, 56 are detached from the clam shell mobile device 52, all three mobile devices can operate as separate, standalone mobile devices independent of the other two mobile devices.

That is, according to embodiments of the invention, when the first tablet mobile device 54 is detached from the clam shell mobile device 52, the clam shell mobile device 52 can operate as a first standalone mobile communication device and the first tablet mobile device 54 can operate as a second standalone mobile communication device. Similarly, when the second tablet mobile device 56 is detached from the clam shell mobile device 52, the second tablet mobile device 56 can operate as a third mobile communication device in addition to the clam shell mobile device 52 and the first tablet mobile device 54.

It will be apparent to those skilled in the art that many changes and substitutions can be made to the embodiments of the invention herein described without departing from the spirit and scope of the invention as defined by the appended claims and their full scope of equivalents.

1. A mobile communication device, comprising:
a first mobile device including a display screen portion and a user input portion; and
at least one second mobile device detachably coupled to the first mobile device,
wherein the first mobile device is configured to function as a first standalone mobile communication device,
wherein the second mobile device is configured to function as a second standalone mobile communication device when the second mobile device is detached from the first mobile device, and
wherein, when the second mobile device is detached from the first mobile device, the first mobile device continues to include the display screen portion and the user input portion.

2. The mobile communication device as recited in claim 1, wherein the second mobile device is detachably coupled to the first mobile device in such a way that does not increase the footprint of the first mobile device.

3. The mobile communication device as recited in claim 1, wherein the first mobile device includes a first mobile device module, a second mobile device module, and a connector element configured to couple the first mobile device module to the second mobile device module in a clam shell configuration.

4. The mobile communication device as recited in claim 1, wherein the second mobile device is a mobile communication device having a tablet configuration.

5. The mobile communication device as recited in claim 1, wherein the second mobile device has a coupling element formed thereon and the first mobile device has a coupling recess formed therein and dimensioned to receive the coupling element in such a way that the second mobile device is detachably coupled to the first mobile device.

6. The mobile communication device as recited in claim 1, wherein the second mobile device is detachably coupled to the first mobile device via a coupling element, wherein the coupling element provides at least one of mechanical coupling and electrical coupling between the second mobile device and the first mobile device.

7. The mobile communication device as recited in claim 1, wherein the first mobile device has a top surface and an opposing bottom surface, wherein the second mobile device has a top surface and an opposing bottom surface, and wherein the second mobile device is detachably coupled to the first mobile device by coupling the top surface of the second mobile device to the bottom surface of the first mobile device.

8. The mobile communication device as recited in claim 1, further comprising a third mobile device detachably coupled to the first mobile device, wherein the third mobile device is configured to function as a third standalone mobile communication device when detached from the first mobile device.

9. The mobile communication device as recited in claim 8, wherein the third mobile device is detachably coupled to the first mobile device in such a way that does not increase the footprint of the first mobile device.

10. The mobile communication device as recited in claim 8, wherein the third mobile device is a mobile communication device having a tablet configuration.

11. The mobile communication device as recited in claim 8, wherein the third mobile device is detachably coupled to at least one of the first mobile device module and the second mobile device module via a coupling element, wherein the coupling element provides at least one of mechanical coupling and electrical coupling between the third mobile device and at least one of the first mobile device module and the second mobile device module.

12. A mobile communication device, comprising:
a first mobile device having a display screen portion and a user input portion;
a second mobile device detachably coupled to the first mobile device; and
a third mobile device detachably coupled to the first mobile device,
wherein the first mobile device is configured to function as a first standalone mobile communication device,
wherein the second mobile device is configured to function as a second standalone mobile communication device when detached from the first mobile device,
wherein the third mobile device is configured to function as a third standalone mobile communication device when detached from the first mobile device,
wherein, when one or both of the second mobile device and the third mobile device is detached from the first mobile device, the first mobile device continues to include the display screen portion and the user input portion.

13. The mobile communication device as recited in claim 12, wherein the second mobile device is detachably coupled to the first mobile device in such a way that does not increase the footprint of the first mobile device, and wherein the third mobile device is detachably coupled to the first mobile device in such a way that does not increase the footprint of the first mobile device.

14. The mobile communication device as recited in claim 12, wherein the first mobile device includes a first mobile device module, a second mobile device module, and a connector element configured to couple the first mobile device module to the second mobile device module in a clam shell configuration.

15. The mobile communication device as recited in claim 12, wherein at least one of the second mobile device is detachably coupled to the first mobile device and the third mobile device is detachably coupled to the first mobile device via a coupling element, wherein the coupling element provides at least one of mechanical coupling and electrical coupling between the coupled mobile devices.

16. The mobile communication device as recited in claim 12, wherein at least one of the second mobile device and the third mobile device has a coupling element formed thereon and the first mobile device has a corresponding coupling recess formed therein and dimensioned to receive the coupling element in such a way that at least one of the second mobile device and the third mobile device second mobile device is detachably coupled to the first mobile device.

17. The mobile communication device as recited in claim 12, wherein the first mobile device has a top surface and an opposing bottom surface, wherein at least one of the second mobile device and the third mobile device has a top surface and an opposing bottom surface, and wherein the at least one second mobile device and third mobile device is detachably coupled to the first mobile device by coupling the top surface of the at least one second mobile device and third mobile device to the bottom surface of the first mobile device.

18. The mobile communication device as recited in claim 12, wherein at least one of the second mobile device and the third mobile device is a mobile communication device having a tablet configuration.

19. A mobile communication device, comprising:
a first mobile device including a display screen portion and a user input portion; and
a coupling element formed on the first mobile device and configured to detachably couple at least one second mobile device to the first mobile device,
wherein the first mobile device is configured to function as a first standalone mobile communication device,
wherein the second mobile device is configured to function as a second standalone mobile communication device when the second mobile device is detached from the first mobile device, and
wherein, when the second mobile device is detached from the first mobile device, the first mobile device continues to include the display screen portion and the user input portion.

20. The mobile communication device as recited in claim 19, wherein the coupling element is configured to detachably couple a third mobile device to the first mobile device,
wherein the third mobile device is configured to function as a third standalone mobile communication device when detached from the first mobile device,
wherein, when one or both of the second mobile device and the third mobile device is detached from the first mobile device, the first mobile device continues to include the display screen portion and the user input portion.
